(19) United States
(12) Patent Application Publication
(10) Pub. No.: US 2005/0201664 A1
(43) Pub. Date: Sep. 15, 2005

(54) Fiber grating pressure wave speed measurement system

(76) Inventors: Eric Udd, Fairview, OR (US); Sean Geoffrey Calvers, Troutdale, OR (US)

Correspondence Address: Eric Udd;Blue Road Research, 376 NE 219TH AVENUE, GRESHAM, OR, 97030, US

(21) Appl. No.: 11/071,278

(22) Filed: Mar. 3, 2005

Related U.S. Application Data
(60) Provisional application No. 60/552,846, filed on Mar. 12, 2004.

(51) Int. Cl. G02B 6/00

(52) U.S. Cl. 385/13; 385/37

(57) ABSTRACT

A fiber grating strain sensing system is used to locate and characterize a high speed environmental event that destroys one or more fiber grating strain sensors as it passes them. The system is very suitable for the detection and characterization of a high intensity pressure wave such as a blast wave due to a detonation. A fiber grating strain sensor is oriented so that the high speed environmental effect passes over it and its reflective spectral profile changes as portions of the fiber grating strain sensor are destroyed. The reflective spectral profile from one or more fiber grating strain sensors are then mixed with the spectral profile of an optical filter onto a high speed output detector. A reference detector may be used to normalize the output signal. The spectral profiles of the fiber grating strain sensors and optical filter may be arranged in several ways that are effective including substantially matching both profiles, establishing opposite spectral slopes and utilization of an optical filter with a substantially flat spectral profile.

This application claims the benefit of U.S. Provisional Application No. 60/552,846 by Eric Udd, Sean Calvert, Michele Winz, Jason Mooney and Nicholas Ortyl, “Fiber Optic Grating Systems”, filed Mar. 12, 2004.

### BACKGROUND OF THE INVENTION

This disclosure describes means to detect the location and speed of a high speed pressure wave that might be encountered after detonation.

This invention relates generally to fiber optic grating systems and more particularly, to the measurement of strain fields using fiber optic grating sensors and their interpretation to assess the speed, characteristics and location of a pressure wave. Typical fiber optic grating sensor systems are described in detail in U.S. Pat. Nos. 5,380,995, 5,402,231, 5,592,965, 5,841,131 and 6,144,026. All of these patents teaching are background for the present invention which optimizes the fiber grating sensor detection, localization and characterization of high speed pressure waves.

The need for measurement of a high speed pressure wave is associated with the characterization of blast waves that might be associated with a detonation and other very high speed pressure events. The need for low cost, a high speed fiber optic grating pressure sensor system that is virtually immune to electromagnetic interference and passive is critical for successful test and measurement of high speed pressure waves. This system has the capability of operating at the extremely high speeds associated with fiber optic systems. A system has been demonstrated by the inventors with a bandwidth of 2 MHz with much higher operating speeds at 10s of MHz being possible near term. Ultimately the fiber optic design and high speed optical detectors that may be employed allow for extremely high detection speeds beyond the GHz level. The system is more practically limited in detection speed by the mechanical response of very small fiber optic grating pressure sensors that have mechanical resonances for standard fibers in the 10s of MHz. Using very small optical fibers may allow systems to approach a hundred MHz or more.

### BRIEF DESCRIPTION OF THE PRESENT INVENTION

In the present invention a high speed fiber grating pressure wave measurement system is described that can assess the location, speed and characteristics of a high speed pressure wave. This invention is particularly directed toward the detection of pressure waves with sufficient intensity to destroy the optical fiber upon passage. High speed, high intensity pressure waves generated by an under water detonation is an example of this type of application.

The invention consists of a light source which illuminates one or more fiber grating strain sensors that are used as the pressure detector and oriented along a path along which the pressure wave location and characteristics are to be measured. The reflected spectral signature is then directed toward a fiber grating filter that mixes with the spectral signal and forms an output light beam that can in turn be used to localize and characterize the high speed pressure wave. Therefore it is an object of the invention to provide a high speed pressure measurement system that is capable of locating the pressure wave front.

Another objective of the invention is to measure the amplitude of the pressure wave.

Another object of the invention is to characterize the pressure distribution of the leading edge of the pressure wave.

### BRIEF DESCRIPTION OF THE DRAWINGS

FIG. 1 is a diagram of the present invention using an array of narrow spectral bandwidth fiber gratings in combination with a spectrally broadband output fiber grating filter.

FIG. 2a is a graph of the intensity with respect to wavelength of the reflected beam from a broadband light source of a sloped filter that might a chirped fiber grating and a fiber grating.

FIG. 2b is a graph of the spectral shift of a fiber grating spectral profile due to compression associated with passage of blast wave.

FIG. 2c is a graph of the amplitude output on a detector as a function of time as the blast wave moves through an array of fiber gratings that may be of substantially the same wavelength.

FIG. 3 is a diagram of the present invention to detect high intensity pressure waves consisting of a chirped fiber grating and a reference filter with substantially overlapping spectral reflection profiles.

FIG. 4 is a graphical illustration of the response of the system shown in FIG. 3 to a high intensity pressure wave traveling along the long axis of the optical fiber containing the chirped fiber grating sensor.

FIG. 5 is a diagram of the present invention to detect high intensity pressure waves consisting of a chirped fiber grating sensor and a reference filter with spectral slopes that in reflection are opposite to each other.

FIG. 6 is a graphical illustration of the response of the system shown in FIG. 5 to a high intensity pressure wave traveling along the long axis of the optical fiber containing the chirped fiber grating sensor.

FIG. 7 is a diagram of the present invention to detect high intensity pressure waves consisting of a chirped fiber grating sensor and a reference filter with a flat reflective response that might be a chirped fiber grating.

FIG. 8 is a graphical illustration of the response of the systems shown in FIG. 7 and FIG. 9 to a high intensity pressure wave traveling along the long axis of the optical fiber containing the chirped fiber grating sensor.

FIG. 9 is a diagram of the present invention to detect a high intensity pressure wave consisting of a chirped fiber grating sensor and a reference filter with a flat reflective response that may be a mirror.

### DETAILED DESCRIPTION OF THE SHOWN EMBODIMENTS

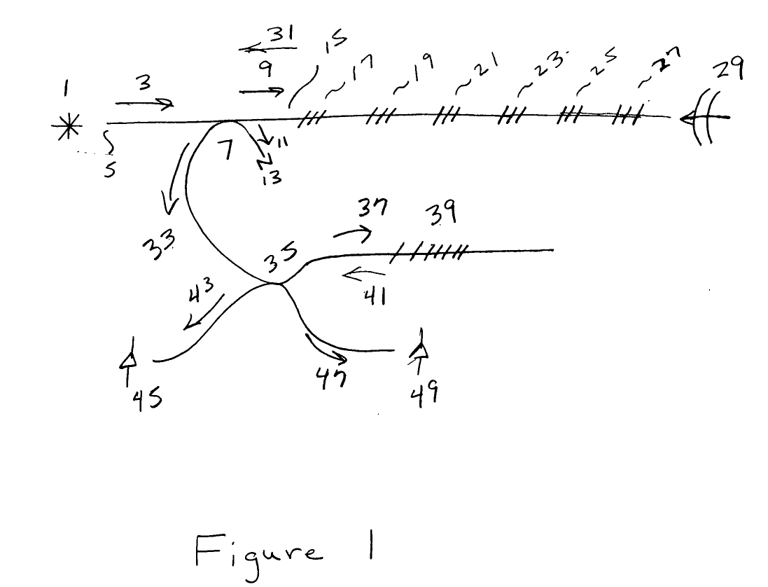

FIG. 1 shows a fiber optic pressure wave measurement system that is designed to measure the speed and amplitude of a high intensity blast pressure wave. A light source 1 that may be a spectrally broadband fiber light source couples the light beam 3 into the optical fiber end 5. The light beam 3 propagates to the fiber beamsplitter 7 where it is divided into the light beams 9 and 11. The light beam 11 propagates out to the terminated fiber 13 and exits the system. The light beam 9 propagates along the fiber 15 and a portion of the light beam 9 is reflected off the fiber grating sensors 17, 19, 21, 23, 25, and 27. These fiber grating sensors may be at different wavelengths but in one embodiment that has good signal to noise ratio all are at substantially the same wavelength. When a blast pressure wave 29 is directed toward the fiber grating sensor 27 it is at first compressed and later destroyed by the passage of the high intensity pressure wave 29. This results in the spectral signal from the fiber grating sensor being shifted under compression toward shorter wavelengths. As the blast pressure wave 29 propagates past each of the fiber grating sensors 27, 25, 23, 21, 19 and 17 each in turn undergoes as shift in the wavelength reflected from the light beam 9 as the pressure wave 29 reaches the fiber grating sensor and then destroys it. The result is that the reflections of the light beam 9 from the array of fiber grating sensors 17, . . . , 27 results in a light beam 31 which combines the spectral signatures from each of the fiber grating sensors 17, . . . , 27 until they are destroyed by the blast pressure wave 31. The light beam 31 then returns to the fiber beamsplitter 7 and a portion of the light beam 31 is directed as the light beam 33 to the fiber beamsplitter 35. A portion of the light beam 35 is directed as the light beam 37 into a leg of the fiber beamsplitter 35 that contains a spectral filter 39 that may be a chirped fiber grating. A portion of the light beam 35 is then reflected off the spectral filter 39 as the light beam 41 back to the fiber beamsplitter 35 and directed as the light beam 43 onto the output detector 45. For reference a second portion of the light beam 33 is split by the fiber beamsplitter 35 into the light beam 47 that is directed into the output detector 49. The detector 49 is used as a reference detector to compensate for light intensity level fluctuations and may be used in combination with the output from detector 47 to normalize the output signal.

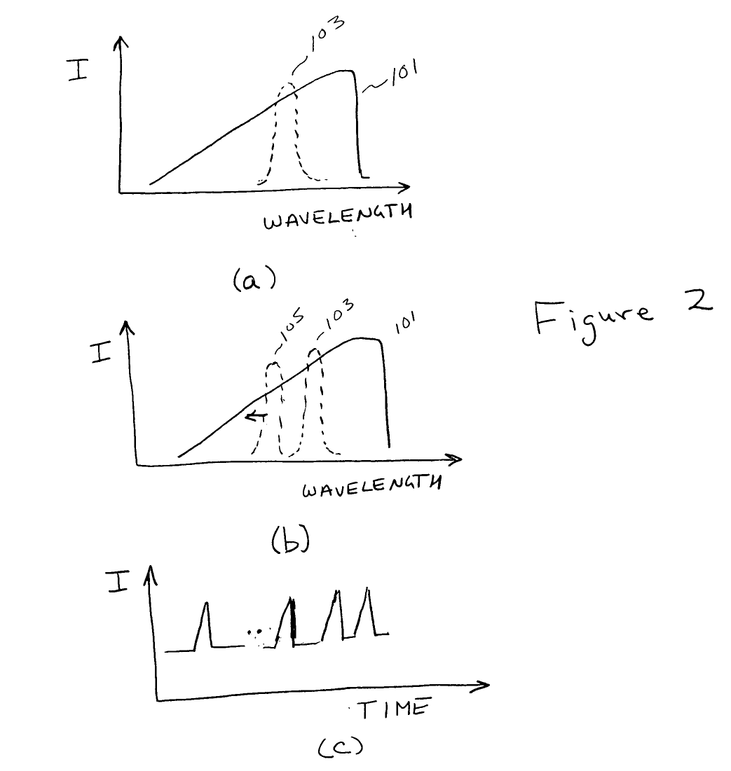

FIG. 2 shows in graphical form the output associated with the system shown in FIG. 1. In FIG. 2a the spectral response curve of a spectral filter 39 is shown in conjunction with the spectral profile 103 associated with one of the fiber grating sensors 17, . . . , 27. In one embodiment all of the fiber grating sensors 17, . . . , 27 may have substantially the same spectral profile wavelength under similar environmental conditions. The system will function if the wavelengths of the fiber grating sensors 17, . . . , 27 are at different wavelengths however the signal to noise ratio may be lower. When the blast pressure wave impacts a fiber grating sensor as is illustrated by FIG. 2b the spectral profile 103 under compression shifts to shorter wavelengths associated with the spectral profile 105. This results in an intensity change on the detector output as a function of the blast pressure wave moving across the fiber grating sensor array as is illustrated by FIG. 2c.

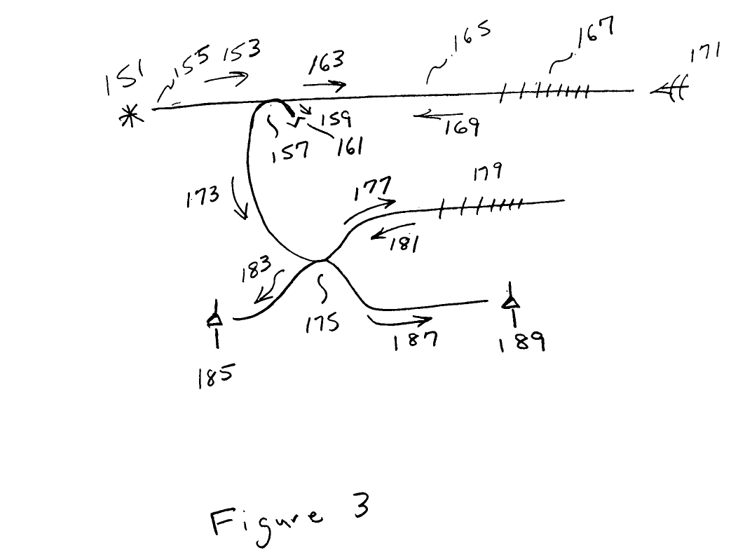

FIG. 3 is an illustration of a system using a chirped fiber grating in combination with a spectral filter that may be a chirped fiber grating to measure the speed and amplitude of a blast wave. The light source 151 that may be a spectrally broadband light source couples a beam of light 153 into the fiber end 155. The light beam 153 propagates to the fiber beamsplitter 157 where it is split into the light beams 159 and 163. The light beam 159 exits the system via the terminated end 161. The light beam 163 continues down the optical fiber 165 to the chirped fiber grating sensor 167 and a portion of the light beam 163 is reflected as the light beam 169. The light beam 169 contains environmental information related to the position and amplitude of the high intensity pressure wave 171 that has a velocity component directed along the long axis of the optical fiber 165. The reflected light beam 169 returns to the fiber beamsplitter 157 and a portion of the light beam 169 is directed as the light beam 173 to the fiber beamsplitter 175. One portion of the light beam 173 is split by the beamsplitter 175 into the light beam 177 that propagates toward the sloped optical filter 179 that may be a chirped fiber grating. The optical filter 179 is designed to have spectral characteristics that are very similar to those of the chirped fiber grating sensor 167. A portion of the light beam 177 reflects off the sloped optical filter 179 as the light beam 181 and returns to the fiber beamsplitter 175. A portion of the light beam 181 is split by the fiber beamsplitter 175 into the light beam 183 which is directed toward the output detector 185 that may be a photodiode. The light beam 173 which enters the fiber beamsplitter 175 is also split into a light beam 187 that is directed toward the reference output detector 189 that may be a photodiode. By taking the ratio of the electrical outputs of the detectors 185 and 189 a normalized output signal may be obtained.

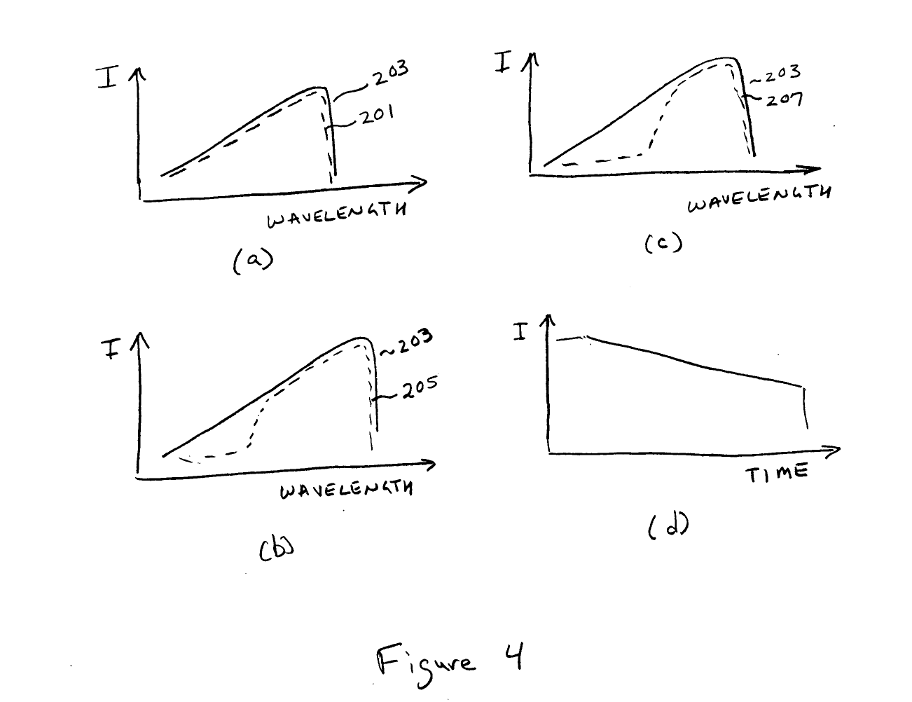

FIG. 4 graphically illustrates the output of the system described in association with FIG. 3. FIG. 4a is a graphical illustration of spectral reflectivity of the chirped fiber grating sensor 201 (element 167 in FIG. 3) relative to the spectral reflectivity of the sloped optical filter 203 (element 179 in FIG. 3). In the case of FIG. 4a the high intensity pressure wave 171 has not arrived at the chirped fiber grating sensor 167 and the spectral profiles 201 and 203 are closely matched. FIG. 4b shows the reflective spectral profile of the partially destroyed chirped fiber grating sensor 205 compared to the reflective spectral profile of the sloped optical filter 203. FIG. 4b corresponds to the situation associated with the high intensity pressure wave 171 propagating through the far end of the chirped fiber grating sensor 167. FIG. 4c shows the reflective spectral profile of the sloped optical filter 203 compared to the reflective spectral profile of the mostly destroyed chirped fiber grating 207. FIG. 4d shows the output of the system associated with FIG. 3 as the high intensity pressure wave propagates along the chirped fiber grating sensor 167 and ultimately destroys it.

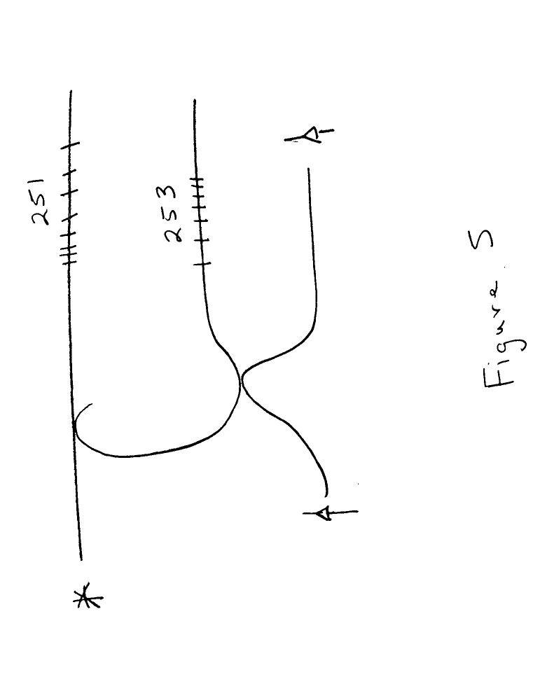

FIG. 5 is a diagram showing a system that is very similar to that shown in FIG. 3. However in this case the chirped fiber grating sensor 251 associated with FIG. 5 is spatially turned 180 degrees with respect to the similar chirped fiber grating sensor associated with FIG. 3. A sloped optical filter 253 which may be a chirped fiber grating has its profile sloped in the opposite direction with that associated with the chirped fiber grating sensor 251.

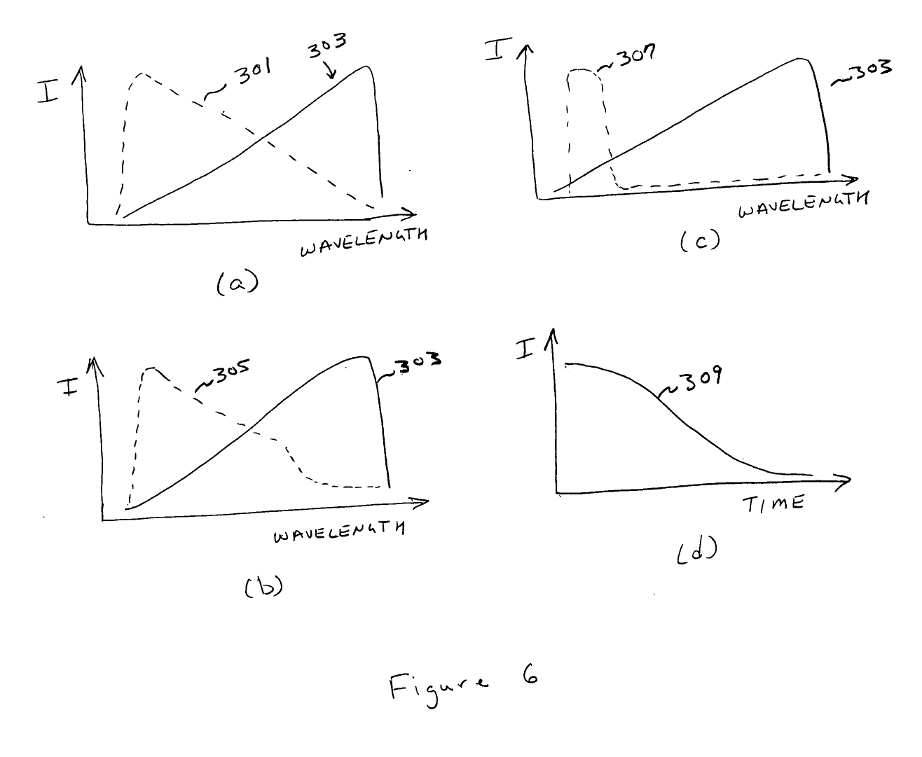

FIG. 6 shows graphically the operation of the system associated with FIG. 5. In FIG. 6a the chirped fiber grating filter reflective spectral profile 301 has a downward slope with respect to increasing wavelength while the reflective profile of the sloped filter 303 has an upward slope. Essentially the same system could be formed by flipping the position of the chirped fiber grating sensor 251 and the sloped optical filter 253 in FIG. 3 by 180 degrees. In this case the spectral profiles 301 and 303 would be reversed. FIG. 6b shows the spectral profile of the chirped fiber grating filter 305 corresponding to a partially destroyed condition relative to the sloped optical filter spectral profile 303. FIG. 6c shows the reflective of the chirped fiber grating filter 307 where the chirped fiber grating filter 251 is mostly destroyed. FIG. 6d shows the output 309 as a function of time as the chirped fiber grating sensor 251 is destroyed.

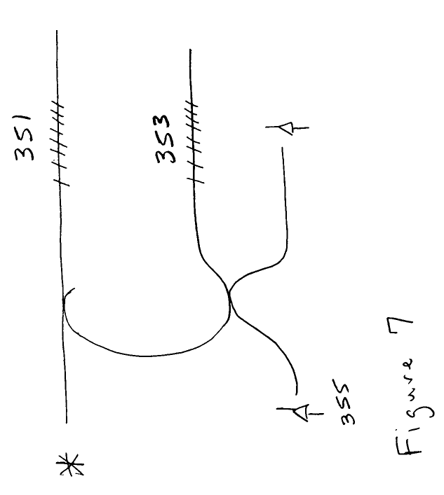

FIG. 7 illustrates a system where most elements are similar to those associated with FIGS. 3 and 5. The chirped fiber grating filter 351 is designed to sense a high speed destructive event that may be a high intensity pressure wave. In the case of FIG. 7 the optical filter 353 has a spectral response that is flat.

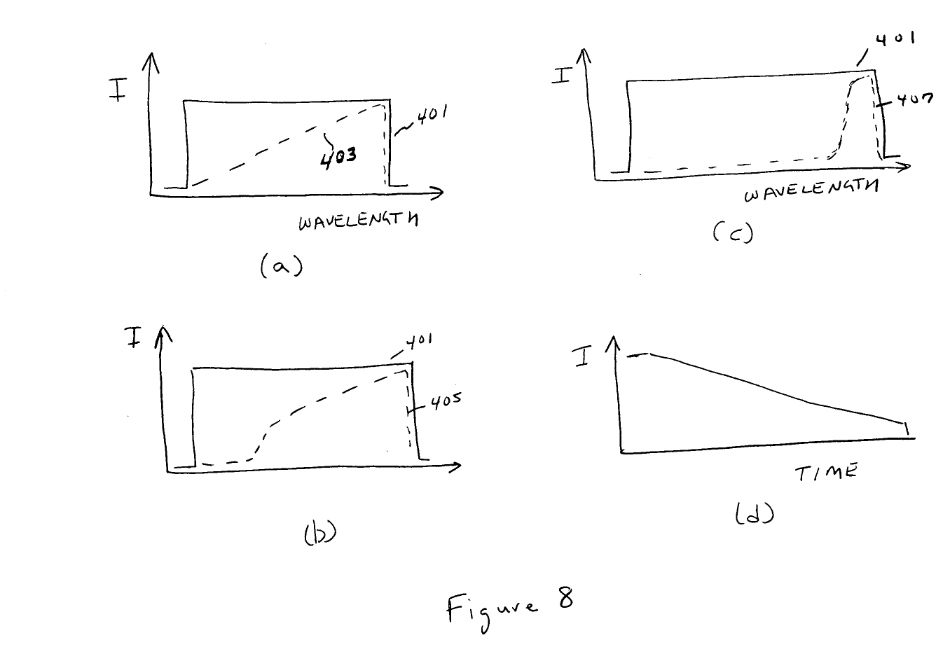

The response of the system associated with FIG. 7 is shown in FIG. 8. FIG. 8a shows the flat spectral response of the optical filter 401 (353) relative to the chirped fiber grating sensor 351 spectral response 403. The case of FIG. 8a is before portions of the chirped fiber grating sensor 351 are destroyed. FIG. 8b shows the chirped fiber grating sensor spectral profile 405 after a portion of the chirped fiber grating sensor 351 is destroyed relative to the flat spectral profile 401. FIG. 8c shows the chirped fiber grating spectral profile 407 relative to the flat spectral profile 401 after much of the chirped fiber grating sensor 351 has been destroyed. FIG. 8d is a graphical illustration of the output from detector 355 as a function of time as the chirped fiber grating sensor 351 is destroyed.

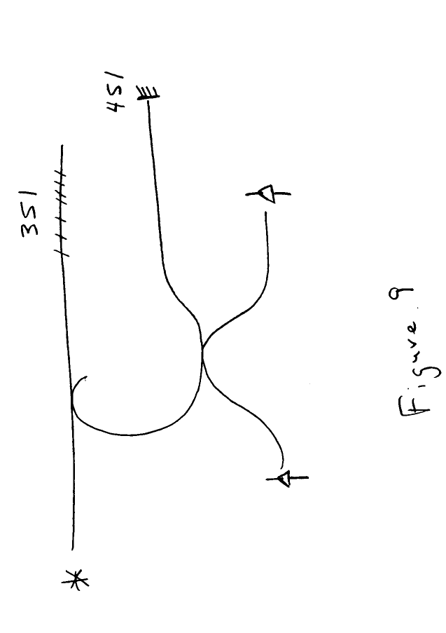

FIG. 9 is a drawing showing that the flat optical filter 353 associated with FIG. 7 can be replaced by a mirror 451 that has a flat reflected spectral response. The output of the system associated with FIG. 9 can be graphically described by FIG. 8. The main advantage of the system associated with FIG. 9 relative to FIG. 8 is that a simple mirror has the potential to be fabricated at much lower cost.

Thus there has been shown and described a novel high intensity pressure wave measurement system that can be used to effectively measure environmental events that destroy an optical fiber and fulfills all the objectives and advantages sought therefore. Many changes, modifications, variations and applications of the subject invention will become apparent to those skilled in the art after the consideration of the specification and accompanying drawings. All such changes modifications, alterations and other uses and applications which do not depart from the spirit and scope of the invention are deemed to be covered by the invention which is limited only by the claims that follow:

1. A high speed environmental fiber optic strain measurement system capable of locating and characterizing a high speed event damage including:
a light source producing a light beam;
a first beamsplitter connected to receive said light beam;
first output port of said first beamsplitter connected to at least one fiber grating strain sensor;
said fiber grating strain sensor being placed in a position to intercept a high speed environmental event,
second output port of said beamsplitter being connected to second beamsplitter;
first output port of said second beamsplitter being connected to an optical filter;
second output port of said second beamsplitter being connected to an optical detector to detect reflected signal from said optical filter;
whereby the location and character of a high speed environmental event may be determined.

2. A high speed environmental fiber optic strain measurement system as defined in claim 1 wherein third output port of said second beamsplitter is connected to an optical detector.

3. A high speed environmental fiber optic strain measurement system as defined in claim 1 wherein said first output port of said first beamsplitter is connected to an array of fiber grating sensors having substantially the same peak wavelength.

4. A high speed environmental fiber optic strain measurement system as defined in claim 1 wherein said optical filter is a chirped fiber grating.

5. A high speed environmental fiber optic strain measurement system as defined in claim 1 wherein said fiber grating strain sensor is a chirped fiber grating sensor.

6. A high speed environmental fiber optic strain measurement system as defined in claim 5 wherein said chirped fiber grating sensor has a spectral reflective profile that is substantially matched to the spectral reflective profile of said optical filter.

7. A high speed environmental fiber optic strain measurement system as defined in claim 5 wherein said chirped fiber grating sensor has a spectral reflective profile that has an opposite slope to the spectral reflective profile of said optical filter

8. A high speed environmental fiber optic strain measurement system as defined in claim 5 wherein said optical filter has a substantially flat reflective profile.

9. A high speed environmental fiber optic strain measurement system as defined in claim 8 wherein said optical filter is a chirped fiber grating.

10. A high speed environmental fiber optic strain measurement system as defined in claim 8 wherein said optical filter is a mirror placed at the end of said first output port of said second beamsplitter

11. A high speed fiber optic measurement system capable of measuring the location and characterizing a high speed environmental event consisting of:
a light source means producing a beam of light;
said beam of light being split by first beam splitting means:
first output of said beam splitting means being connected to at least one fiber grating strain sensor;
second output of said beam splitting means being connected to second beam splitting means;
first output of said second beam splitting means being connected to an optical filter;
said second output of said second beam splitter means being connected to optical detection means to receive a reflective signal from said optical filter means;
whereby the location and character of a high speed environmental event may be determined.

12. A high speed fiber optic measurement system as defined in claim 11 wherein third output port of said second beam splitting means is connected to optical detection means.

13. A high speed fiber optic measurement system as defined in claim 11 wherein said first output port of said first beam splitting means is connected to an array of fiber grating sensors having substantially the same peak wavelength

14. A high speed fiber optic measurement system as defined in claim 11 wherein said optical filter means is a chirped fiber grating.

15. A high speed fiber optic measurement system as defined in claim 11 wherein said fiber grating strain sensor is a chirped fiber grating sensor.

16. A high speed fiber optic measurement system as defined in claim 15 wherein said chirped fiber grating sensor has a spectral reflective profile that is substantially matched to the spectral reflective profile of said optical filter.

17. A high speed environmental fiber optic strain measurement system as defined in claim 15 wherein said chirped fiber grating sensor has a spectral reflective profile that has an opposite slope to the spectral reflective profile of said optical filter means.

18. A high speed environmental fiber optic strain measurement system as defined in claim 15 wherein said optical filter means has a substantially flat reflective profile.

19. A high speed environmental fiber optic strain measurement system as defined in claim 18 wherein said optical filter means is a chirped fiber grating.

20. A high speed environmental fiber optic strain measurement system as defined in claim 8 wherein said optical filter means is a mirror placed at the end of said first output port of said second beamsplitter
